(19) United States
(12) Patent Application Publication
(10) Pub. No.: US 2025/0346023 A1
(43) Pub. Date: Nov. 13, 2025

(54) FLEXIBLE LAMINATED BOARD AND PREPARATION METHOD THEREOF

(71) Applicant: International Centre for Bamboo and Rattan, Chaoyang District (CN)

(72) Inventors: Hanzhou YE, Chaoyang District (CN); Ge WANG, Chaoyang District (CN)

(21) Appl. No.: 18/950,848

(22) Filed: Nov. 18, 2024

(30) Foreign Application Priority Data
May 11, 2024 (CN) 202410581098.8

(51) Int. Cl. B32B 21/04; B32B 37/10

(52) U.S. Cl. CPC B32B 21/04; B32B 37/10; B32B 2305/024; B32B 2307/7376

(57) ABSTRACT

A flexible laminated board and a preparation method thereof are provided. The flexible laminated board includes a laminated board body. The laminated board body is formed by laminating and laying a plurality of board units in a thickness direction, and an outermost surface of the laminated board body in a lamination direction is a board surface of the laminated board body. At least one board surface of the laminated board body is provided with a groove with a shape and a depth, and the board surface of the laminated board body is divided into a plurality of regional units by the groove.

### CROSS REFERENCE TO RELATED APPLICATION

This patent application claims the benefit and priority of Chinese Patent Application No. 202410581098.8 filed with the China National Intellectual Property Administration on May 11, 2024, the disclosure of which is incorporated by reference herein in its entirety as part of the present application.

### TECHNICAL FIELD

The present disclosure relates to the technical field of building and ornament materials, and in particular to a flexible laminated board, and a preparation method thereof.

### BACKGROUND

Plant-derived materials such as bamboo and wood are natural renewable resources, which are widely used in building and ornament materials and other fields due to their excellent physical properties and environmental protection characteristics. For example, they can be used as wallboard, floor and ceiling. A thin bamboo (wood) laminated board made by laminating bamboo or wood or a composite of both is an innovative bamboo (wood) processed product, which is made by hot pressing one or more layers of bamboo (wood) veneer or bamboo (wood) sheet. However, due to the small thickness of the thin bamboo (wood) laminated board, the internal stress is high, which is easy to cause deformation, warping and other problems, leading to the limitation on application scope of the thin bamboo (wood) laminated board to some extent.

In the related technologies, the internal stress of the thin bamboo (wood) laminated board is mainly reduced by changing the assembly structure design or adopting special preparation processes. For example, the dimensional stability of the bamboo (wood) veneer can be enhanced by changing the assembly mode of the bamboo (wood) veneer or increasing the resin content. In addition, there are some technologies to optimize the internal structure of the thin bamboo (wood) laminated board by changing the parameters of hot pressing, such as temperature, pressure, and time, so as to reduce its internal stress.

By adopting the above technical solutions, although the problems of deformation and warping of the thin bamboo (wood) laminated board can be alleviated to a certain extent, due to the presence of a large amount of internal stress in the thin board, the problems of deformation and warping will still occur with the passage of time and changes in the external environment, thus affecting the appearance and quality of the thin bamboo (wood) laminated board. Moreover, the rigid boards prepared by the above methods have certain limitations in the application fields such as curved surfaces and irregular shapes.

### SUMMARY

The present disclosure provides a flexible laminated board and a preparation method thereof, aiming to solve the problems effectively in the prior art where the internal stress of a laminated board is large, deformation and warping are difficult to solve, and the rigidity of the board limits its application. The problem of excessive internal stress of the laminated board can be effectively solved, and further, the flexibility of the board is achieved, and the application field is broadened.

The present disclosure provides a flexible laminated board, including:

a laminated board body formed by laminating and laying a plurality of board units in a thickness direction, an outermost surface of the laminated board body in a lamination direction being a board surface of the laminated board body; and

a groove with a shape and a depth provided on at least one board surface of the laminated board body, the board surface of the laminated board body being divided into a plurality of regional units by the groove.

In some embodiments, the flexible laminated board further includes a first liner laid between one of the plurality of board units provided with the groove and an adjacent board unit.

In some embodiments, the flexible laminated board further includes a second liner laid outside the at least one board surface provided with the groove of the laminated board body.

In some embodiments, the first liner and/or the second liner includes a fiber cloth.

In some embodiments, the fiber cloth includes one or more selected from the group consisting of a plant fiber cloth, a glass fiber cloth, and a carbon fiber cloth.

In some embodiments, the board unit has a thickness of 0.1 mm to 5 mm.

In some embodiments, the fiber cloth has a thickness of 0.02 mm to 1 mm.

In some embodiments, a shape of the groove includes one selected from the group consisting of a dot matrix shape, a short-line matrix shape, a tic-tac-toe shape, a honeycomb shape, a wave matrix shape, and a long-line matrix shape.

The present disclosure further provides a method for preparing a flexible laminated board, including:

laminating and laying: laminating and laying a plurality of board units in a forward direction or at an angle;

press forming: putting a resulting laminated material into a press and conducting cold press forming or hot press forming to obtain a laminated board body; and

groove processing: processing a groove with a shape and a depth on a board surface of the laminated board body by means of laser cutting, physical notching, biological enzyme treatment, microbial erosion, chemical etching, template imprinting notching, etc.

In some embodiments, the forward direction refers to follow the direction of the fibers of the board unit, and at an angle refers to at a certain angle to the direction of the fibers of the board unit.

In some embodiments, the laminating and laying further includes:

laying a first liner between a board unit provided with the groove and an adjacent board unit.

In some embodiments, after the groove processing, the method further includes:

laying a second liner outside a board surface provided with the groove of the laminated board body.

In some embodiments, in the laminating and laying, a moisture content of the board unit is not greater than 20%.

The present disclosure provides a flexible laminated board, and a preparation method thereof. A continuous board surface of the laminated board body can be divided into a plurality of regional units by the groove, such that the internal stress of the laminated board body can be effectively released at the groove, thereby improving the internal structure of the laminated board, solving the problems of warping and deformation of the laminated board, and ensuring that the board can maintain a stable shape and quality under long-term use and the external environment changes. Further, the groove is conducive to the flexibility of a rigid board, such that the rigid board is more suitable for scenes with special shape requirements such as curved surfaces and irregular shapes, and the application field is broadened.

### BRIEF DESCRIPTION OF THE DRAWINGS

To describe the technical solutions of the present disclosure or in the prior art more clearly, a brief introduction to the accompanying drawings used in the description of the embodiments or the prior art solutions is provided below. Apparently, the accompanying drawings in the following description are merely some embodiments of the present disclosure, and those skilled in the art may still obtain other drawings based on these accompanying drawings without inventive labor.

FIG. 1 is a structural schematic diagram of the flexible laminated board according to an embodiment of the present disclosure;

FIG. 2 is a structural schematic diagram of the groove according to an embodiment of the present disclosure;

FIG. 3 is a structural schematic diagram of the groove according to another embodiment of the present disclosure;

FIG. 4 is a structural schematic diagram of the groove according to another embodiment of the present disclosure;

FIG. 5 is a structural schematic diagram of the groove according to another embodiment of the present disclosure;

FIG. 6 is a structural schematic diagram of the groove according to another embodiment of the present disclosure;

FIG. 7 is a structural schematic diagram of the groove according to another embodiment of the present disclosure;

FIG. 8 is a flow diagram of the method for preparing a flexible laminated board according to an embodiment of the present disclosure.

In the drawings:

10 represents laminated board body; 100 represents board unit; 11 represents groove; 12 represents first liner; and 13 represents second liner.

### DETAILED DESCRIPTION OF THE EMBODIMENTS

To make the objects, technical solutions and advantages of the present disclosure more clearly, the technical solutions in the embodiments of the present disclosure will be described clearly and completely with reference to the accompanying drawings in the embodiments of the present disclosure. Apparently, the described embodiments are merely a part rather than all of the embodiments of the present disclosure. All other embodiments obtained by those skilled in the art based on the embodiments of the present disclosure without inventive labor shall fall within the scope of the present disclosure.

In order to understand the flexible laminated board and a preparation method thereof provided by the present disclosure conveniently, the application background is explained at first. A thin bamboo (wood) laminated board made by laminating bamboo or wood or a composite of both is an innovative bamboo (wood) processed product, which is made by hot pressing one or more layers of bamboo (wood) veneer or bamboo (wood) sheet. However, due to the small thickness of the thin bamboo (wood) laminated board, the internal stress is high, which is easy to cause deformation, warping and other problems, leading to limitation on the application scope of the thin bamboo (wood) laminated board to some extent.

In the related technologies, the internal stress of the thin bamboo (wood) laminated board is mainly reduced by changing the assembly structure design or adopting special preparation processes. For example, the dimensional stability of the bamboo (wood) veneer can be enhanced by changing the assembly mode of the bamboo (wood) veneer or increasing the resin content. In addition, there are some technologies to optimize the internal structure of the thin bamboo (wood) laminated board by changing the parameters of hot pressing, such as temperature, pressure, and time, so as to reduce its internal stress.

However, in actual applications, it is found that adopting the above technical solutions may at least result in the following technical problems:

1. The effect is limited. Although the warping and deformation of the thin bamboo (wood) laminated board can be alleviated to some extent by designing the assembly structure and increasing the resin content in the prior art, the effect is limited, especially in the aspect of greatly reducing the internal stress of the board, there is no significant breakthrough in the prior art, and the prior art solutions still face challenges.

2. Although various measures have been made to reduce the apparent warping and deformation of the thin bamboo (wood) laminated board in the prior art, there are still a large amount of internal stress in the thin bamboo (wood) laminated board. Even if the deformation and warping problems seem to be solved in a short time, the problems will still reappear with the passage of time and changes in the external environment, thus affecting the appearance and quality of the products.

3. The thin bamboo (wood) laminated board prepared by the prior art solutions has high rigidity, which makes it difficult for the thin board to adapt to some special shapes, such as curved surfaces, irregular shapes, and other application fields, thus limiting the flexibility and practicability of the thin board in some design aspects.

Based on the problems and findings above, the present disclosure provides a flexible laminated board, and a preparation method thereof, which can effectively solve the problem of excessive internal stress in a laminated board, ensuring that the board can maintain a stable shape and quality under long-term use and the external environmental changes. Further, the flexibility of the board is achieved, and the application field of the board is broadened.

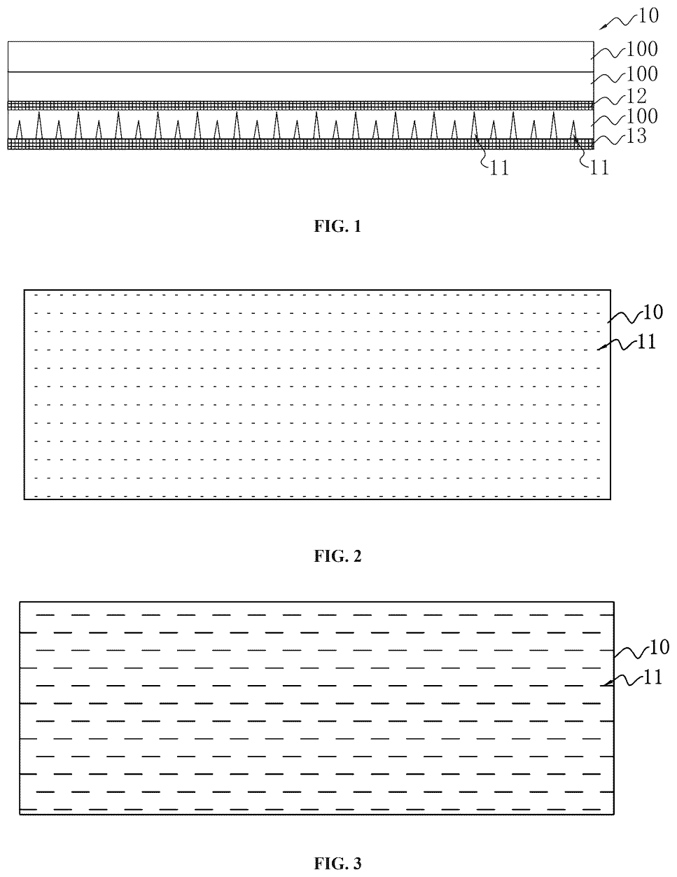

The flexible laminated board and a preparation method thereof according to some embodiments are described below with reference to FIG. 1 to FIG. 8.

Referring to FIG. 1, a flexible laminated board includes a laminated board body 10, wherein the laminated board body 10 is formed by laminating and laying a plurality of board units 100 in a thickness direction, and an outermost surface of the laminated board body 10 in a lamination direction is a board surface of the laminated board body 10; and at least one board surface of the laminated board body 10 is provided with a groove 11 with a preset shape and depth, and the board surface of the laminated board body 10 is divided into a plurality of regional units by the groove 11.

In actual applications, a continuous board surface of the laminated board body 10 can be divided into a plurality of regional units by the groove 11, such that the internal stress of the laminated board body 10 can be effectively released at the groove 11, thereby improving the internal structure of the laminated board, solving the problems of warping and deformation of the laminated board, and ensuring that the board can maintain a stable shape and quality under long-term use and the external environment changes. Further, the groove 11 is also conducive to the flexibility of the rigid board, such that the rigid board is more suitable for scenes with special shape requirements such as curved surfaces and irregular shapes, and the application field is broadened.

It could be understood that the board unit 100 above may be a bamboo sheet, such as a bamboo strip, a thin bamboo strip, a bamboo bundle curtain, and a bamboo curtain, or may be other wooden sheets, which can specifically be selected and configured according to actual needs. In addition, specification parameters of the board unit 100 and the assembly structure between the plurality of board units 100 can be designed according to the actual application scenes. For example, fiber directions of adjacent board units 100 may be perpendicular to each other or at other angles, and a single board unit 100 may has a thickness of 0.1 mm to 5 mm.

According to the different positions of the plurality of the board units in the laminating and laying, the plurality of board units 100 can be divided into a facing sheet and a core sheet. The facing sheet constitutes the two board surfaces of the laminated board body 10, and the core sheet is located between the two facing sheets. The groove 11 is opened on one of the facing sheets. Specifically, the groove 11 can be formed by laser cutting, physical notching, biological enzyme treatment, microbial erosion, chemical etching, template imprinting notching, etc. The depth and shape of the groove 11 may be flexibly designed according to actual needs, such as, the appearance requirements of the product, the thickness of the facing sheet, and the internal stress of the laminated board body 10.

In an embodiment, referring to FIG. 2, the groove 11 is of a dot matrix shape, that is, a plurality of dot-shaped grooves 11 are arranged in a matrix along the length and width directions of the board surface of the laminated board body 10.

In another embodiment, referring to FIG. 3, the groove 11 is of a short-line matrix shape, that is, a plurality of short-line-shaped grooves 11 are arranged in a matrix along the length and width directions of the board surface of the laminated board body 10.

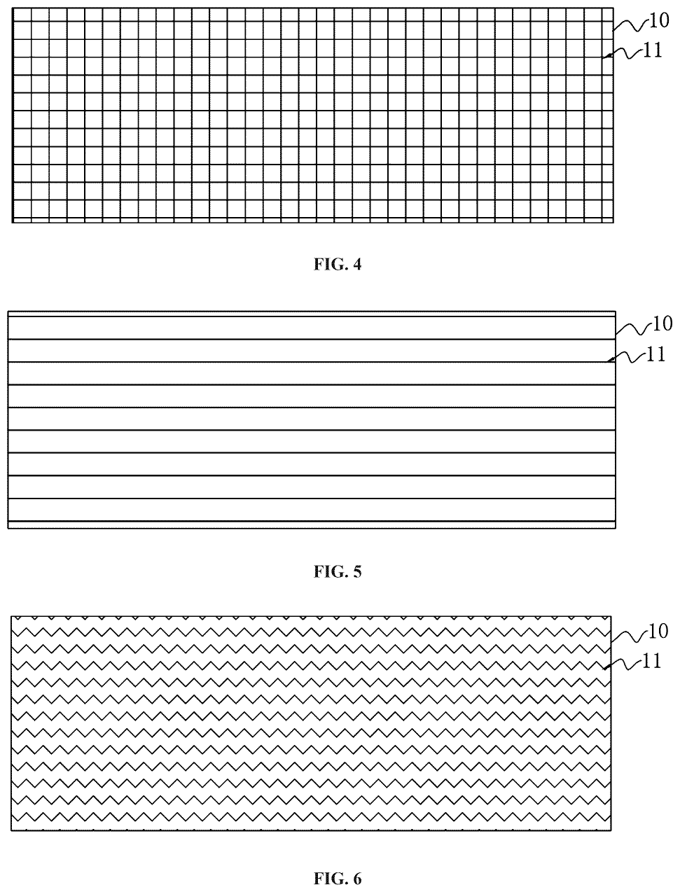

In another embodiment, referring to FIG. 4, the groove 11 is of a tic-tac-toe shape, that is, line-shaped grooves 11 are arranged horizontally and vertically intersecting on the board surface of the laminated board body 10.

In another embodiment, referring to FIG. 5, the groove 11 is of a long-line matrix shape, that is, on the board surface of the laminated board body 10, long-line-shaped grooves 11 extend from one side of the board surface to the opposite side, and a plurality of grooves 11 are parallel to each other.

In another embodiment, referring to FIG. 6, the groove 11 is of a wave matrix shape that is, on the board surface of the laminated board body 10, wave-shaped grooves 11 extend from one side of the board surface to the opposite side, and a plurality of grooves 11 are parallel to each other.

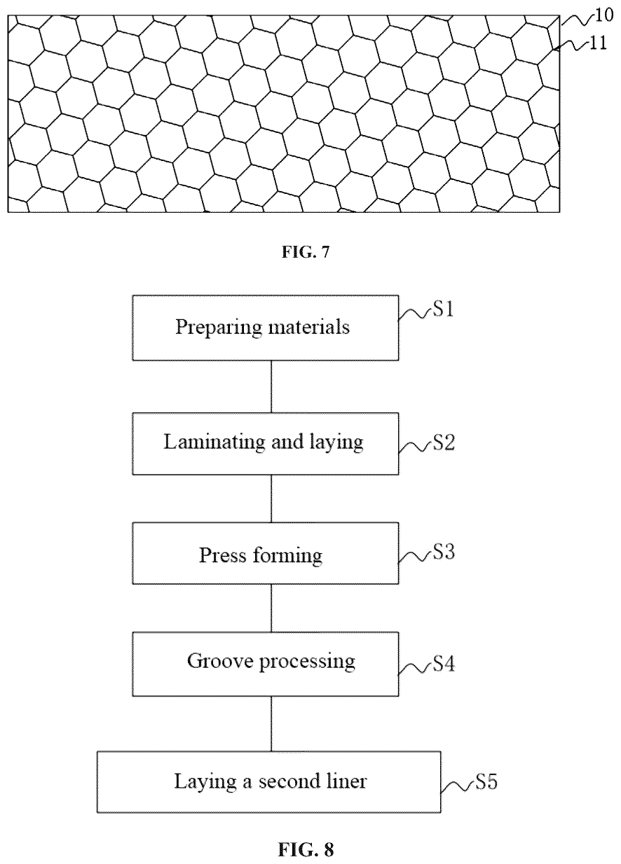

In another embodiment, referring to FIG. 7, the groove 11 is of a honeycomb shape.

Certainly, the groove 11 is not limited to the shapes or arrangements listed above, other shapes or arrangements of the groove 11 are also applicable as long as the stress release effect can be achieved.

However, in actual applications, it is found that due to the natural fiber orientation of plant-derived materials such as bamboo, wood, straw, hemp, etc., the following aspects should be paid attention to when opening the groove 11:

Shape, spacing, and distribution: The shape of the groove 11, the spacing between the grooves 11, and the distribution of the grooves 11 should take into account the fiber orientation of the plant-derived materials, thus ensuring stress release and the strength and stability of the board.

Depth and width of the groove 11: The depth of the groove 11 should not be too deep, so as not to weaken the strength of the board, but it should not be too shallow either, otherwise the stress may not be released effectively. The width of the groove 11 should also be appropriate, thus ensuring stress release and the strength and stability of the board.

After the groove 11 is processed on the board unit 100, although the stress release effect can be achieved, the mechanical properties of the board unit will inevitably change, affecting the bonding stability with an adjacent board unit 100.

Based on the above problems, in order to ensure the bonding stability between adjacent board units 100 in the laminated board body 10, referring to FIG. 1, a first liner 12 is laid between a board unit 100 provided with the groove 11 and an adjacent board unit 100, and a second liner 13 is laid outside a board surface provided with the groove 11 of the laminated board body 10. Both the first liner 12 and the second liner 13 are continuous liners.

Through the first liner 12, the mechanical properties of the board unit 100 can be improved, ensuring that the board unit 100 can still be well bonded with the adjacent board unit 100 after the groove 11 is opened, thus effectively avoiding the problem of falling off. Further, the board unit 100 can be divided into a plurality of regional units by the groove 11, and the first liner 12 can provide a basis for the processing of the groove 11, providing a continuous liner for different regional units inside the laminated board body 10, connecting the regional units into a whole, such that the board unit 100 can still maintain good integrity and strength after the groove 11 is opened. The second liner 13 may provide a continuous liner for different regional units outside the board surface of the laminated board body 10, thus ensuring the integrity, stability, and strength of the laminated board body 10.

In some embodiments, the first liner 12 and the second liner 13 have various selectable materials and specification parameters. The first liner 12 and the second liner 13 with different materials and specification parameters can achieve different effects, and the specific choice can be made flexibly according to actual needs.

In a specific embodiment, the first liner 12 and the second liner 13 each are made of a fiber cloth, such as a plant fiber cloth, a glass fiber cloth, or a carbon fiber cloth.

The first liner 12 and the second liner 13 may be made of the fiber cloth of the same material, or the fiber cloth of different materials. Each of the first liner 12 and the second liner 13 can be obtained by layering a single-layer fiber cloth, for example, a first liner 12 or a second liner 13 with a required thickness can be directly obtained by directly layering a single-layer fiber cloth with a specific thickness. It may also be obtained by layering a plurality of fiber cloth, for example, a first liner 12 or a second liner 13 with a required thickness can be obtained by stacking and layering a plurality of thinner fiber cloth.

The thickness of the first liner 12 and the second liner 13 may be selected according to the actual application scenes, such as the thickness range that can be achieved by fiber cloth made of different materials, the overall thickness of a laminated board, etc. In this embodiment, the first liner 12 and the second liner 13 each have a thickness of 0.02 mm to 1 mm.

Similarly, the width of the first liner 12 and the second liner 13 can be adjusted according to the actual application scenes, such as the overall width of a laminated board. In this embodiment, the first liner 12 and the second liner 13 each have a width of 10 cm.

Certainly, the first liner 12 and the second liner 13 are not limited to the above materials and specification parameters. Based on actual needs and application scenes, the specification parameters of the first liner 12 and the second liner 13 can be adaptively adjusted.

The method for preparing a flexible laminated board according to some embodiments is described below. The method described below can be referred to in correspondence with the flexible laminated board described above.

Referring to FIG. 8, a method for preparing a flexible laminated board includes the following steps:

S1. Preparing materials: A board unit 100 made of a required material is selected as a lamination unit, such as a wood veneer, a bamboo strip, a thin bamboo strip, a bamboo bundle curtain, and a bamboo curtain. A moisture content of the board unit 100 should be controlled within 20%, thus ensuring the smooth operation of the subsequent pressing process. Meanwhile, a first liner 12 and a second liner 13 are prepared. The first liner 12 and the second liner 13 may be specifically a fiber cloth liner, such as a plant fiber cloth, a glass fiber cloth, and a carbon fiber cloth. The first liner 12 and the second liner 13 each have a thickness of 0.02 mm to 1 mm.

S2. Laminating and laying: A plurality of the board units 100 are laminated and laid in a certain order in a forward direction (follow the direction of the fibers of the board unit) or at a certain angle. A thickness of a single board unit 100 is controlled within 0.1 mm to 5 mm. The first liner 12 is laid between a board unit 100 provided with the groove 11 and an adjacent board unit 100. The first liner 12 can be obtained by laying a single layer of fiber cloth, for example, a first liner 12 with a required thickness can be directly obtained by directly laying a single layer of fiber cloth with a specific thickness, or can also be obtained by stacking and laying a plurality of thinner fiber cloth.

S3. Press forming: A resulting laminated material is put into a press and subjected to cold press forming or hot press forming, wherein the pressing temperature is based on the curing temperature of the selected adhesive. The adhesive may be phenolic resin, urea-formaldehyde resin, isocyanate, a thermoplastic rubber powder adhesive film, an inorganic adhesive, a compound adhesive thereof, etc. Generally, the hot press forming is conducted at a temperature of 90° C. to 150° C. and a pressure of 1 MPa to 20 MPa for 10 minutes to 45 minutes to obtain a laminated board body 10.

S4. Groove 11 processing: A groove 11 with a preset shape and depth is processed on a board surface of the laminated board body 10 by means of laser cutting, physical notching, biological enzyme treatment, microbial erosion, chemical etching, template imprinting notching, etc., thus releasing the internal stress of the laminated board body 10. It can improve the internal structure of the laminated board to achieve flexibility, and increase the use value of the laminated board without affecting the appearance and quality.

The specific shape and depth of the groove 11 can be flexibly designed according to the actual needs, such as the appearance requirements of the product, the thickness of the facing sheet and the internal stress of the laminated board body 10. In some specific embodiments, the groove 11 is of a dot matrix shape, a short-line matrix shape, a tic-tac-toe shape, a honeycomb shape, a wave matrix shape, and a long-line matrix shape, and a depth of the groove 11 is controlled at about 0.1 mm to 3 mm.

S5. Laying a second liner layer 13: A second liner 13 is laid outside a board surface provided with the groove 11 of the laminated board body 10. The second liner 13 can provide a continuous liner for different regional units outside the board surface of the laminated board body 10, thus ensuring the integrity, stability, and strength of the laminated board body 10.

The second liner 13 can be obtained by laying a single-layer fiber cloth, for example, a second liner 13 with a required thickness can be directly obtained by directly laying a single-layer fiber cloth with a specific thickness, or obtained by stacking and laying a plurality of thinner fiber cloth.

The innovation point of the present disclosure is that a continuous board surface of the laminated board body 10 can be divided into a plurality of regional units by the groove 11, such that the internal stress of the laminated board body 10 can be effectively released at the groove 11, thereby improving the internal structure of the laminated board, solving the problems of warping and deformation of the laminated board, and ensuring that the board can maintain a stable shape and quality under long-term use and the external environment changes. Further, the groove 11 is also conducive to the flexibility of a rigid board, such that the rigid board is more suitable for scenes with special shape requirements such as curved surfaces and irregular shapes, and the application field is broadened.

Finally, it should be noted that the above embodiments are only used to illustrate the technical solutions of the present disclosure rather than limiting. Although the present disclosure has been described in detail with reference to the foregoing embodiments, those skilled in the art should understand that it is still possible to modify the technical solutions described in the foregoing embodiments, or to replace some technical features with equivalents. However, these modifications or substitutions do not make the essence of the corresponding technical solutions depart from the spirit and scope of the technical solutions of various embodiments of the present disclosure.

What is claimed is:

1. A flexible laminated board, comprising:
a laminated board body formed by laminating and laying a plurality of board units in a thickness direction, an outermost surface of the laminated board body in a lamination direction being a board surface of the laminated board body; and
a groove with a shape and a depth provided on at least one board surface of the laminated board body, the board surface of the laminated board body being divided into a plurality of regional units by the groove.

2. The flexible laminated board according to claim 1, further comprising a first liner laid between one of the plurality of board units provided with the groove and an adjacent board unit.

3. The flexible laminated board according to claim 2, further comprising a second liner laid outside the at least one board surface provided with the groove of the laminated board body.

4. The flexible laminated board according to claim 3, wherein the first liner and/or the second liner comprises a fiber cloth.

5. The flexible laminated board according to claim 4, wherein the fiber cloth comprises one or more selected from the group consisting of a plant fiber cloth, a glass fiber cloth, and a carbon fiber cloth.

6. The flexible laminated board according to claim 4, wherein the fiber cloth has a thickness of 0.02 mm to 1 mm.

7. The flexible laminated board according to claim 1, wherein a shape of the groove comprises one selected from the group consisting of a dot matrix shape, a short-line matrix shape, a tic-tac-toe shape, a honeycomb shape, a wave matrix shape, and a long-line matrix shape.

8. A method for preparing a flexible laminated board, comprising:
laminating and laying: laminating and laying a plurality of board units in a forward direction or at an angle;
press forming: putting a resulting laminated material into a press and conducting cold press forming or hot press forming to obtain a laminated board body; and
groove processing: processing a groove with a shape and a depth on a board surface of the laminated board body.

9. The method for preparing the flexible laminated board according to claim 8, wherein the laminating and laying further comprises:
laying a first liner between a board unit provided with the groove and an adjacent board unit.

10. The method for preparing the flexible laminated board according to claim 8, wherein after the groove processing, the method further comprises:
laying a second liner outside a board surface provided with the groove of the laminated board body.
